(19) United States
(12) Patent Application Publication
(10) Pub. No.: US 2011/0022487 A1
(43) Pub. Date: Jan. 27, 2011

(54) Food Container Sale Method

(76) Inventors: Mary Jo Cook, Oakland, CA (US); Lisa Phillips, Danville, CA (US); Marcus Wang, Oakland, CA (US); James Farr, Dublin, CA (US); William L. Smith, Pleasanton, CA (US)

Correspondence Address: THE CLOROX COMPANY, P.O. BOX 24305, OAKLAND, CA, 94623-1305, US

(21) Appl. No.: 12/509,846

(22) Filed: Jul. 27, 2009

(51) Int. Cl. G06Q 90/00; G06Q 30/00; G06Q 50/00

(52) U.S. Cl. 705/23; 705/500

(57) ABSTRACT

A method for selling individual containers used for the storage of fresh foods comprising the steps of providing individual containers in store and adjacent a fresh food product to be purchased, and charging the shopper for the container on a per container basis separately from the food purchased. The bags or containers used in the method of the invention will include at least one feature or characteristic that adds value for the consumer over and above the bags currently provided for free by grocery stores in the produce section.

### BACKGROUND OF THE INVENTION

1. Field of the Invention

The present invention relates to an in-store method for providing containers to a consumer, where the containers are characterized by having at least one product storage enhancing characteristic and permitting the consumer to purchase the container individually and not based on the weight of the container.

2. Description of the Related Art

There are many known materials and methods related to the purchase and storage of fresh food items, such as fruits, meat, fish, vegetables, coffee beans and the like in a grocery store or “farmer's market” setting. Most commonly, a shopper is given a container, such as a plastic or paper bag or wrap, into which the shopper or shop keeper places the desired product for purchase. Most often, the container and product are then carried to the point of purchase where the combined bag and product are weighed and the consumer is charged for the combination. In some settings, the store will permit, or require, that the store staff or shopper weigh and label the food items in the department in which they are displayed in order to speed the purchase of the item at the checkout counter and to avoid the consumer having to pay for the weight of the container with his or her purchase. This process can include the placement of a universal product or so-called “bar” code on the outside of the container so that the item can be scanned at a checkout counter.

In order to minimize the cost to the store owner of providing these plastic or paper containers to the consumer in the store, the materials that are provided, for example plastic bags, are made of very inexpensive material; a material that has little value in terms of protecting and storing the product. These materials provide the benefit of permitting the shopper to carry the food item (say, for example, a few apples) to the front counter for purchase. The material from which the bag is made is also extremely light, making the cost of the bag as charged to the consumer by weight, de minimis. On the other hand, the plastic bag provides no protection or storage benefit when taken home. That is, the item that has been carried from the store in the plastic bag must typically be removed from the plastic bag (or other freely supplied container) in order to avoid faster spoilage caused by the characteristics of the bag. Further, the use of these bags or other containers is wasteful, since they are most often not sturdy enough to be reused.

Published US patent application 2006/0171606 A1 describes a bag having characteristics that provide the benefit of permitting quick inspection of the contents, for example at airport security or other security checkpoints where such bags and their contents need to be inspected. This application also describes a business method in which such bags are made available for sale to a consumer/user near their point of use, generating revenue for the seller.

There are many disclosures of plastic bags and other containers that are suitable for the packaging and storage of fresh food items, such as fresh fruits and vegetables, and that are made of materials (or are configured in a particular way) so as to permit the food item to remain unspoiled for an extended period of time. That is, these containers are designed to prolong the time before the product becomes spoiled relative to storage without a container (e.g. simply placed in a refrigerator) or in the thin film plastic bags given away in the grocery store. Such containers are sometimes available to customers of the same store in which fresh food products are sold, however, they are not sold individually and are not typically positioned in the same area of the store as the fresh food. Thus, for example, customers who are purchasing fruits or vegetables will typically use the free plastic bags in the produce section, take them home, remove the produce from the free bag and place it in a separate storage container that will permit the produce to remain fresh for a longer period of time. Or, the customer will take the produce home in the provided plastic bag and store it in that bag, resulting in relatively fast spoilage of the produce.

### SUMMARY OF THE INVENTION

The present invention comprises a method for individually selling a container, such as a recloseable and/or resealable plastic bag or other container, the container having at least one characteristic for improving the storage time or quality of a fresh food item stored in the container. In one form, the method is accomplished by making a storage container according to the invention individually available in the section of a store selling the food item, permitting the customer access to the individual container (and permitting the customer to place the food item in the container), and charging the customer separately from the food item for the container on a per container basis (i.e. typically not by weight), for example when the customer reaches the checkout stand of the store. The method provides the customer with a number of advantages: being able to directly place the desired food item in the container at the store, being able to purchase the container separately and not in bulk, and to avoid having to replace the food item in a different storage container when the purchase is brought home. These advantages, coupled with the use of a container that keeps the food fresher longer, provides significant added value to the purchaser/consumer. Overall, for the purchaser, this results in less handling of the food item, avoiding possible contamination and/or bruising, and an increased chance that the food item will be stored properly when taken home. For the seller, a new revenue stream is created as consumers will better appreciate the value of using a container according to the invention which is made individually available to them close to the time and place in the store where the consumer decides to purchase the fresh food.

### DETAILED DESCRIPTION

The invention is a method for selling individual containers used for the storage of fresh foods comprising the steps of providing individual containers for customer use positioned adjacent a fresh food product to be purchased, and charging the shopper for the container on a per container basis separately from the food purchased.

In one form of the invention the method comprises providing a shopper in a grocery and/or produce store access to individual storage containers or bags. The containers can be made available in any of many known ways, for example if the containers are flexible bags, then from a roll of such bags positioned adjacent a display of produce. Storage bags and containers according to the method of the invention are known in the art but have not heretofore been made available for individual use and separate purchase in the store. For example, the bags can be sealable and/or resealable plastic bags such as are sold under brands such as GLAD® or others. According to the invention, however, these bags will be provided for separate and individual purchase rather than in a box or other package of, say, ten, twenty or fifty or more bags. Most advantageously, the bags (or other containers) used in the method of the invention will include at least one feature or characteristic that adds value for the consumer over and above the bags currently provided for free by grocery stores in the produce section. A feature of such bags will be one that provides an extended time of freshness during storage over and above the time that is provided by the plastic bags of the prior art that are commonly provided by the store and not separately charged for.

Bags that provide extended freshness can include structural features that provide this benefit (e.g. engineered perforations or breathable films), and/or they may include chemical components that enhance or extend storage time. By “extended freshness” we mean the period of time over which the food item remains fresh in the sense of appearance, taste and/or smell. Where a chemical component is used to provide a benefit, the component may be integrated into the material from which the bag is formed, or it may be included in a component that is added to or inserted in the bag. Such component can be, for example, an insert in the bag which, in addition to including such chemical component, may also absorb moisture and/or provide a cushioning or protective benefit for the produce or other food product stored in the bag.

The characteristic that can be incorporated into the bag or other container used in the method of the invention can relate to the solution of any problem presented when fresh food is placed in the container. For example, the characteristic could be odor reduction for foods that may produce odors (e.g. onions, brocolli or meat from a deli counter). Other characteristics that could be incorporated into the containers used in the invention could include desiccants, liquid absorbents, ethylene scavengers and oxygen scavengers. One known example of the type of engineered material that can be incorporated into containers according to the invention is disclosed in U.S. Pat. No. 5,891,376 (which is incorporated herein by reference in its entirety), which describes controlled gas permeability film materials that have the advantage of permitting longer term storage of vegetables and other foods.

Access to bags according to the invention can be simple (bags placed nearby a fresh food display) or the bags or other containers could be made available from a dispensing machine. If a machine is used, the store would have the opportunity to charge for the container at the time of dispensing. Additionally, the store could use space on a dispensing machine to describe the benefits of using the containers for storage, and permit the user to purchase containers individually by depositing a coin in the machine, or by using any electronic means, such as the swipe of a credit or debit card, using an input code provided by the store for the purchasers account, or by wireless signal sent to the machine, for example from a cell phone or other device carried by the consumer. In any case, it is most preferred that the containers be positioned adjacent to the fresh food that would be placed in the containers and/or in a position in which a customer would have a line-of-sight to the containers while shopping for the fresh food as a reminder of the availability and benefit of using the containers.

Containers that can be used in the method of the invention may be made of any material suitable for the carrying and storage of the fresh food with which they will be used. Plastic and paper will be the most common examples. The containers may take the form of a bag (structured or unstructured) or a harder plastic container, similar to those sold under the Tupperware® or Gladware® brands.

An important aspect of the invention is the opportunity for the store to sell, and for the consumer to buy, the container individually for immediate use in the store and pay for it separately from the food in the container. This can be accomplished many ways. In one form of the method of the invention, the store will charge the customer for the container on a “per container” basis at the time of checkout, along with the food. Another approach would be to permit the customer to purchase the container while shopping, for example in the produce section of the store, from a kiosk or machine. In either case, the method of the invention differs from the current method for purchasing fresh food in the thin plastic bags commonly given away by grocers. In this current and prior method the food and bag are weighed together at the time of checkout and the customer may pay some amount, although it may be very small, by weight of the bag along with the food. In the method according to the invention, however, the customer pays for the container not by weight, but on a price-per-container basis. The advantage is that the consumer can purchase only so many containers as are needed at a particular time, and at the same time, place the fresh food in the container in the store. There is then no need to replace the food in a different container when the food is taken home, simplifying storage and maximizing the chances that the fresh food will be stored properly to insure freshness. The food will then stay fresher longer and the consumer will benefit from avoiding spoilage before the food was to be consumed. The amount charged will reflect this benefit. For the grocer the advantage is the revenue stream generated by the consumer's purchase of the container.

What is claimed is:

1. A method for selling an individual storage container, the method comprising the steps of:
(1) providing an individual food storage container to a store customer, the storage container including a characteristic that permits food stored in the container to remain fresh longer than if the food item is not stored in the container; and
(2) permitting the customer to purchase the individual container on a per unit basis.

2. The method of claim 1 wherein the storage container comprises a plastic bag including an integrated closure.

3. The method of claim 1 wherein the storage container is a plastic tub or tray having a separate lid, which lid combines with the tub or tray to form a closure for the container.

4. The method of claim 1 further comprising the step of displaying the food storage container in the produce section of the store.

5. The method of claim 1 further comprising the step of permitting the customer to purchase the individual container at the point of its display.

6. The method of claim 1 further comprising the step of including a universal product code marking on the container for use at the point of purchase of the individual container.

7. The method of claim 1 wherein the characteristic that permits food stored in the container to remain fresh longer than if the food item is not stored in the container is selected from the group consisting of a controlled gas permeability film material, an odor control agent, a desiccant or other moisture absorbing component, and a means for limiting or eliminating contact between pieces of the food in the container or contact between the food in the container and surfaces outside the container.

8. The method of claim 1 wherein the container includes a controlled gas permeability film material.

9. A method for selling individual plastic reclosable storage containers in combination with food items in store, the method comprising the steps of
(1) displaying a food item for sale,
(2) displaying a plastic, closable storage container for individual sale in a position where the container is visible to a customer at the same time as the food item, the container having a characteristic that permits the food item to be stored and retain freshness in the container for a period longer than if the food item is not stored in the container or bag, and
(3) selling the individual storage container to the shopper for a per-container price.

10. The method of claim 9 wherein the storage container includes a component that acts as a desiccant.

11. The method of claim 9 wherein the storage bag or container includes a component that acts as a moisture or odor absorbent.

12. The method of claim 9 further comprising the steps of placing a computer readable or bar code on the container and reading the code at the time of purchase to determine the price to be charged for the container.

13. A method for selling individual plastic reclosable storage containers in combination with food items in a store, the method comprising the steps of
(1) displaying a food item for sale in a store,
(2) displaying a plastic, reclosable storage container for sale in the store adjacent said food item and in a manner accessible to a shopper the container including a controlled gas permeability film material, and
(3) selling the individual storage container to a customer for a container price.

14. The method for selling individual plastic reclosable storage containers in combination with food items in store according to claim 13, further comprising the step of visually depicting by way of a display adjacent a food item the storage benefit of using the container for storing the food item as opposed to storing the food item without the benefit of the container.
